(19) United States
(12) Patent Application Publication
(10) Pub. No.: US 2009/0208760 A1
(43) Pub. Date: Aug. 20, 2009

(54) ENERGY-TRANSMITTING OR ULTRAVIOLET LIGHT-TRANSMITTING OPTICAL FIBER PREFORM AND PRODUCTION PROCESS THEREOF

(75) Inventors: Madoka KUWAHARA, Chiyoda-ku (JP); Akio KOIKE, Chiyoda-ku (JP); Kaname OKADA, Chiyoda-ku (JP); Tomonori OGAWA, Koriyama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Asahi Glass Company, Limited, Chiyoda-ku (JP)

(21) Appl. No.: 12/429,513

(22) Filed: Apr. 24, 2009

Related U.S. Application Data
(63) Continuation-in-part of application No. PCT/JP09/51647, filed on Jan. 30, 2009.

(30) Foreign Application Priority Data
Jan. 30, 2008 (JP) 2008-018715

(51) Int. Cl. B32B 17/06; C03C 3/06; C03B 37/075; C03B 37/10

(52) U.S. Cl. 428/428; 501/53; 65/397

(57) ABSTRACT

The present invention is to provide an optical fiber preform suitable for the production of an energy-transmitting or ultraviolet light-transmitting optical fiber, which has an excellent transmittance of a high-energy light of 50 KW/cm² or more in terms of laser peak power or an ultraviolet light, to be transmitted through the optical fiber and which exhibits excellent durability that causes almost no deterioration by the irradiation with those two lights; and a production process thereof. The present invention relates to an energy-transmitting or ultraviolet light-transmitting optical fiber preform, having a core and a cladding each comprising a silica glass, wherein the core has an average OH concentration of 0 to 10 ppm, an average O₂ concentration of ≦10¹⁵ molecules/cm³, an average ODC (I) concentration of ≦10¹³ defects/cm³, an average ODC (II) concentration of ≦10¹² defects/cm³ and an average F concentration of ≦1,000 ppm, and the cladding has an average OH concentration of 0 to 10 ppm, an average F concentration of ≧7,000 ppm, an average O₂ concentration of ≦10¹⁶ molecules/cm³, an average ODC (I) concentration of ≦10¹³ defects/cm³ and an average ODC (II) concentration of ≦10¹² defects/cm³.

### TECHNICAL FIELD

The present invention relates to an energy-transmitting or ultraviolet light-transmitting optical fiber preform, particularly an optical fiber preform for transmitting ultraviolet light at a wavelength of 300 nm or shorter; a core material and a cladding material each used in the optical fiber preform; and a process for producing the optical fiber preform.

### BACKGROUND ART

Conventionally, an optical fiber has been used, for example, in the field of medical equipment or for the production apparatus of a semiconductor as well as for the information-communication or the like. It is also employed for an excimer laser used in the lithography in the process of producing a semiconductor.

The optical fiber is formed of a synthetic silica glass or the like, and is a product in which a cladding having a low refractive index is provided on the outer circumference of a core having a high refractive index. The core is doped with germanium, phosphorus or the like for raising the refractive index, and the cladding is doped with boron, F or the like for reducing the refractive index.

On the other hand, an excimer laser such as ArF laser or KrF laser emits a high-energy ultraviolet light at a wavelength of 193 nm or 248 nm. The high-energy ultraviolet light, that is, deep ultraviolet light with a wavelength of 200 to 300 nm or vacuum ultraviolet light with a wavelength of 200 nm or shorter, is absorbed by H₂O or O₂ during propagation in air. Therefore, the loss is great, and hence the transmission was impossible. Therefore, in view of the necessity of ensuring a light path kept in a vacuum state or filled with an inert gas, exposure devices using an excimer laser were large. For reducing the size of the exposure devices using an excimer laser, it was demanded to apply an optical fiber that facilitates the handling.

The optical fiber is also used for the propagation of a high-intensity laser that is employed in the processing and welding. With the progress of high-speed processing, an energy-transmitting fiber with good light resistance was demanded so as to propagate a higher energy. The energy-transmitting fiber as referred to herein indicates a fiber for transmitting a high energy of 50 KW/cm² or more, preferably 500 KW/cm² or more, more preferably 5 MW/cm² or more, in terms of laser peak power.

The device utilizing deep ultraviolet light or vacuum ultraviolet light also includes an excimer lamp. As to the excimer lamp, for example, a Xe₂ lamp, a KrCl lamp and a XeCl lamp emit deep or vacuum ultraviolet light of 172 nm, 222 nm and 308 nm, respectively. Such an excimer lamp is used in a surface cleaning apparatus in which contamination attached to the surface of a semiconductor wafer or a liquid-crystal display glass is optically decomposed and removed by the irradiation with ultraviolet light. For the same reasons as in the case of the exposure machine, there was a demand also in the surface cleaning device using an excimer lamp to apply an optical fiber that enables reduction in the size and facilitates the handling.

In order to cope with these demands, an ultraviolet light-transmitting optical fiber comprising a core formed of a silica glass containing F in an amount of from 100 to 1,000 ppm is disclosed (see, Patent Document 1).

However, the ultraviolet light-transmitting optical fiber described in Patent Document 1 leaves the following problems to be solved.

### [Problem 1]

The F-doped optical fiber in the invention of Patent Document 1 exhibits a remarkably excellent performance in terms of transmittance of deep ultraviolet light or vacuum ultraviolet light as well as durability to irradiation with ultraviolet light in comparison with prior optical fibers, but was found to involve a problem that the transmittance in the deep ultraviolet light region was lower, in a long wavelength side, than what was expected from the glass transmission spectrum of a preform rod before drawing into an optical fiber. This is caused because the absorption edge of the optical fiber after fiber-drawing is not the genuine absorption edge (Urbach edge) of the preform rod, but is limited by an oxygen-deficient defect induced by the fiber-drawing (Oxygen-Deficient Center (I) (hereinafter referred to as “ODC (I)”).

### [Problem 2]

A fiber having a small fiber diameter of about 200 μm has difficulties that the transmittance is low and the durability becomes deteriorated, depending on the fiber-drawing conditions. These occur because, due to heating and fiber drawing during the fiber-drawing process, oxygen-deficient defects (Oxygen-Deficient Center (II) (hereinafter referred to as “ODC (II)”) and E′ centers are generated.

Although the E′ centers can be eliminated by subjecting the F-doped silica glass fiber containing such defects to a hydrogen treatment, the ODC (II) cannot be eliminated.

The F-doped silica glass fiber containing ODC (II) is disadvantageous in that the transmittance is deteriorated by the irradiation with ultraviolet light such as ArF excimer laser.

In order to solve the problem 1, Patent Document 2 discloses an ultraviolet light-transmitting optical fiber comprising a core formed of a silica glass having an F content of 100 to 1,000 wt. ppm, and a cladding, around the core, having a refractive index lower than that of the core, wherein the oxygen-deficient defect (ODC (I)) concentration in the optical fiber is 10¹² defects/cm⁻³ or less. The ultraviolet light-transmitting optical fiber disclosed in Patent Document 2 is described as being an ultraviolet light-transmitting optical fiber that is scarcely deteriorated by the irradiation with ultraviolet light and is excellent in durability.

It is disclosed that the ultraviolet light-transmitting optical fiber disclosed in Patent Document 2 preferably satisfies the following conditions:

OH content of core: from 4 to 7 wt. ppm, and

Cladding: a silica glass containing F in an amount of from 1,000 to 7,000 ppm, or a silica glass containing boron in an amount of from 2,000 to 10,000 ppm.

Also, in order to solve the problem 2, Patent Document 3 discloses a deep ultraviolet light-transmitting optical fiber comprising a core formed of a silica glass containing a predetermined amount of F, a cladding provided on the core and formed of a silica glass containing a predetermined amount of F or boron, and a protective coat layer provided on the cladding, wherein the optical fiber has been subjected to an oxygen treatment and a hydrogen treatment. It is disclosed that this deep ultraviolet light-transmitting optical fiber preferably satisfies the following conditions:

ODC (II) concentration: 10¹² defects/cm³ or less,

F content of core: from 100 to 1,000 ppm, and

Cladding: a silica glass containing F in an amount of from 1,000 to 7,000 ppm, or a silica glass containing boron in an amount of from 2,000 to 10,000 ppm.

The deep ultraviolet light-transmitting optical fiber disclosed in Patent Document 3 is described as being an ultraviolet light-transmitting optical fiber that is scarcely deteriorated by the irradiation with ultraviolet light and is excellent in durability.

Patent Document 1: JP-A-2002-214454

Patent Document 2: JP-A-2006-45012

Patent Document 3: JP-A-2005-266645

### DISCLOSURE OF THE INVENTION

### Problems to be Solved by the Invention

However, the ultraviolet light-transmitting optical fibers described in Patent Documents 2 and 3 have the following problems.

In an ultraviolet light-transmitting optical fiber, the F concentrations in the core and the cladding constituting the optical fiber are preferably made high for raising the transmittance of ultraviolet light. In the ultraviolet light-transmitting optical fibers described in Patent Documents 2 and 3, the initial transmittance was improved by a hydrogen treatment, so that the resistance of the optical fiber against ultraviolet light was not sufficiently enhanced.

Incidentally, in Patent Documents 2 and 3, from the saturating amount of F to the silica glass, the upper limit of the F concentration is set to be 7,000 ppm. The reason therefor can be considered as follows. If the F concentration of the cladding is made higher than 7,000 ppm, the concentration of the oxygen-deficient defects (ODC (I), (II)) in the optical fiber becomes high and the oxygen-deficient defect concentrations specified in Patent Documents 2 and 3 cannot be satisfied.

Although patent Documents 2 and 3 disclose forming a cladding from a silica glass containing from 2,000 to 10,000 ppm of boron, when a cladding is formed from a silica glass containing boron, the resistance against ultraviolet light is inferior as compared with the case of forming a cladding from a silica glass containing F.

In order to solve the foregoing problems in the conventional techniques, an object of the present invention is to provide: an optical fiber preform suitable for the production of an energy-transmitting or ultraviolet light-transmitting optical fiber, which optical fiber preform has an excellent transmittance of an energy, specifically a high-energy light of 50 KW/cm² or more in terms of laser peak power or an ultraviolet light, to be transmitted through the optical fiber, and which exhibits excellent durability that causes almost no deterioration by the irradiation with those two lights; a production process thereof; and a core material and a cladding material each used in the optical fiber preform.

### Means for Solving the Problems

In order to achieve the foregoing objects, the present invention provides a core material for use in an energy-transmitting or ultraviolet light-transmitting optical fiber preform, comprising a silica glass, and

having an average OH concentration of from 0 to 10 ppm, an average O₂ concentration of ≦10¹⁵ molecules/cm³, an average ODC (I) concentration of ≦10¹³ defects/cm³, an average ODC (II) concentration of ≦10¹² defects/cm³, and an average F concentration of ≦1,000 ppm.

In the core material of the present invention, the average ODC (I) concentration is preferably ≦10¹² defects/cm³.

The present invention also provides a cladding material for use in an energy-transmitting or ultraviolet light-transmitting optical fiber preform, comprising a silica glass, and

having an average OH concentration of from 0 to 10 ppm, an average F concentration of ≧7,000 ppm, an average O₂ concentration of ≦10¹⁶ molecules/cm³, an average ODC (I) concentration of ≦10¹³ defects/cm³, and an average ODC (II) concentration of ≦10¹² defects/cm³.

In the cladding material of the present invention, the average ODC (I) concentration is preferably ≦10¹² defects/cm³.

The present invention also provides an energy-transmitting or ultraviolet light-transmitting optical fiber preform (hereinafter referred to as “the preform of the present invention”) having a core and a cladding, each comprising a silica glass,

wherein the core has an average OH concentration of 0 to 10 ppm, an average O₂ concentration of ≦10¹⁵ molecules/cm³, an average ODC (I) concentration of ≦10¹³ defects/cm³, an average ODC (II) concentration of ≦10¹² defects/cm³, and an average F concentration of ≦1,000 ppm, and

wherein the cladding has an average OH concentration of 0 to 10 ppm, an average F concentration of ≧7,000 ppm, an average O₂ concentration of ≦10¹⁶ molecules/cm³, an average ODC (I) concentration of ≦10¹³ defects/cm³, and an average ODC (II) concentration is ≦10¹² defects/cm³.

In the preform of the present invention, the core preferably has an average ODC (I) concentration of ≦10¹² defects/cm³ and the cladding preferably has an average ODC (I) concentration of ≦10¹² defects/cm³.

In the preform of the present invention, the core preferably contains F in a concentration satisfying the following formula:

x≦2.8×10⁶−{(y−2.8×10⁶)²+3.5×10¹⁰}^{1/2}

wherein y is the average F concentration (ppm) of the cladding and x is the average F concentration (ppm) of the core.

Also, in the preform of the present invention, it is preferred that in the region of ±20 μm from the interface between the core and the cladding, the average OH concentration is from 0 to 10 ppm, the average ODC (I) concentration is ≦10¹⁵ defects/cm³ and the average ODC (II) concentration is ≦10¹⁴ defects/cm³.

Also, in the preform of the present invention, it is preferred that in the region of ±10 μm from the interface between the core and the cladding, the average OH concentration is ≦50 ppm, the average ODC (I) concentration is ≦10¹⁶ defects/cm³ and the average ODC (II) concentration is ≦10¹⁵ defects/cm³.

The present invention also provides a process for producing an energy-transmitting or ultraviolet light-transmitting optical Fiber preform having a core and a cladding each comprising a silica glass (hereinafter referred to as “the production process of a preform of the present invention”), the process comprising subjecting

a core material having an average OH concentration of 0 to 10 ppm, an average O₂ concentration of ≦10¹⁵ molecules/cm³, an average ODC (I) concentration of ≦10¹³ defects/cm³, an average ODC (II) concentration of ≦10¹² defects/cm³, and an average F concentration of ≦1,000 ppm, and

a cladding material having an average OH concentration of 0 to 10 ppm, an average F concentration of ≧7,000 ppm, an average O₂ concentration of ≦10¹⁶ molecules/cm³, an average ODC (I) concentration of ≦10¹³ defects/cm³, and an average ODC (II) concentration of ≦10¹² defects/cm³

to precision polishing and precision cleaning and then to fabrication of an optical fiber preform.

In the production process of a preform of the present invention, the core material preferably contains F in a concentration satisfying the following formula:

x≦2.8×10⁶−{(y−2.8×10⁶)²+3.5×10¹⁰}^{1/2}

wherein y is the average F concentration (ppm) of the cladding material and x is the average F concentration (ppm) of the core material.

In the production process of a preform of the present invention, it is preferred that the average ODC (I) concentration of the core material is ≦10¹² defects/cm³, and that the average ODC (I) concentration of the cladding material is ≦10¹² defects/cm³.

Also, in the production process of a preform of the present invention, the precision polishing and precision cleaning preferably satisfy the following conditions (1) to (3):

(1) the surface after the treatments has a surface roughness Ra of 10 nm or less,

(2) the surface after the treatments is free from a particle with a size of 50 μm or more, and

(3) the surface after the treatments is free from a scratch with a width of 11 μm or more.

In the present specification, the term “ppm” means to represent “mass ppm” unless otherwise indicated.

### ADVANTAGEOUS EFFECTS OF THE INVENTION

The optical fiber produced using the preform of the present invention becomes an energy-transmitting or ultraviolet light-transmitting optical fiber that has a low transmission loss when transmitting a high-energy light of 50 KW/cm² or more in terms of laser peak power or an ultraviolet light and exhibits excellent durability that causes almost no deterioration by the irradiation with both lights.

### BRIEF DESCRIPTION OF THE DRAWINGS

FIG. 1 is a graph showing the measurement results of transmission spectrum on samples of Examples 1 and 4.

FIG. 2 is a graph showing the SIMS analysis results on samples of Examples 1 and 4.

### BEST MODE FOR CARRYING OUT THE INVENTION

The preform of the present invention and the production process thereof are described below.

The preform of the present invention has a core and a cladding, each comprising a silica glass, wherein the core and the cladding satisfy the following conditions, respectively:

### [Core]

The average OH concentration is from 0 to 10 ppm, the average O₂ concentration is ≦10¹⁵ molecules/cm³, the average ODC (I) concentration is ≦10¹³ defects/cm³, the average ODC (II) concentration is ≦10¹² defects/cm³, and the average F concentration is ≦1,000 ppm; and

### [Cladding]

The average OH concentration is from 0 to 10 ppm, the average F concentration is ≧7,000 ppm, the average O₂ concentration is ≦10¹⁶ molecules/cm³, the average ODC (I) concentration is ≦10¹³ defects/cm³, and the average ODC (II) concentration is ≦10¹² defects/cm³.

In the preform of the present invention, since the average OH concentrations of the core and cladding are as very low as 10 ppm or less, a large part of the core and the cladding is composed of the basic structure (Si—O—Si) of a silica glass. Even after drawing into an optical fiber, the optical fiber keeps the tendency that the OH concentration is low. As a result, the optical fiber becomes an energy-transmitting or ultraviolet light-transmitting optical fiber that less causes a refractive index change accompanied with a volume reduction of the silica glass upon irradiation with a high-energy light of 50 KW/cm² or more in terms of laser peak power or with an ultraviolet light and exhibits excellent durability that causes almost no deterioration by the irradiation with both lights.

The mechanism of the change in volume of the silica glass upon irradiation with a high-energy light or an ultraviolet light has not been clearly revealed, but it is presumed that when a high electric field of a laser or the like used as a high-energy light or an ultraviolet light is applied, the OH group in the silica glass undergoes rearrangement and hence a refractive index change accompanied with a volume reduction is caused.

Also, since the average OH concentrations of the core and cladding are very low, the optical fiber produced using the preform scarcely experiences a phenomenon that the transmittance transitionally changes with respect to the electric field at the time when transmitting a high-energy light or an ultraviolet light. This is a favorable property for the energy-transmitting or ultraviolet light-transmitting optical fiber.

In the preform of the present invention, the average OH concentrations of the core and cladding are preferably from 0 to 8 ppm, more preferably from 0 to 4 ppm.

If the average O₂ concentrations in the core and cladding of the preform are high, an excess oxygen defect may be generated. If an excess oxygen defect is present in the core and cladding of the preform, a non-bridging oxygen radical (NBOHC) may be generated from the excess oxygen defect at the time when drawing the preform to produce an optical fiber. The generation of NBOHC causes a reduction in the transmittance of the optical fiber, an elevation of the absolute refractive index, a fluctuation of the refractive index distribution, or generation of fluorescence.

Furthermore, if the average O₂ concentrations in the core and cladding of the preform are high, an excess oxygen defect may be generated in the core and cladding also when drawing the preform to produce an optical fiber.

If an excess oxygen defect is present in the core and cladding of the optical fiber, NBOHC may be generated from the excess oxygen defect when irradiated with an ultraviolet ray.

In the preform of the present invention, the core and cladding have as very low average O₂ concentration as 10¹⁵ molecules/cm³ or less and 10¹⁶ molecules/cm³ or less, respectively, and therefore, generation of an excess oxygen defect in the core and cladding is suppressed. Furthermore, generation of an excess oxygen defect in the core and cladding is suppressed also when drawing the preform to produce an optical fiber. As a result, in an optical fiber produced using the preform, the numbers of excess oxygen defects and NBOHC present in the core and cladding become significantly small, and an optical fiber scarcely causing deterioration upon irradiation with a high-energy light or an ultraviolet light and exhibiting excellent durability is obtained.

Also, if the average O₂ concentrations in the core and cladding of the preform are high, a bubble may be generated at the interface between the core and the cladding. The bubble generated at the interface between the core and the cladding causes a problem such as strength deterioration in the optical fiber produced by drawing the preform.

Furthermore, it is known that when the O₂ concentration is high, the absorption edge of the silica glass shifts to the longer wavelength (see, K. Awazu and H. Kawazoe, “Gaseous species and their photochemical reaction in SiO₂”, Journal of Non-Crystalline Solids (U.S.A.), Vol. 179, No. 2, pp. 214-225 (1994)).

The center of the absorption peak resides in the vicinity of 150 nm, but the absorption tail also effects on the wavelength region of 190 nm or less. In addition, when O₃ is produced from O₂ by the irradiation with a high-energy light or an ultraviolet light, an absorption peak of O₃ appears at 259 nm to decrease the transmittance. Therefore, the resistance to a high-energy light or an ultraviolet light deteriorates.

In the preform of the present invention, the average O₂ concentrations in the core and cladding are significantly low. Therefore, generation of a bubble at the interface between the core and the cladding is prevented. As a result, the optical fiber produced using the preform becomes an excellent energy-transmitting or ultraviolet light-transmitting optical fiber which is free from a bubble at the interface between the core and the cladding.

In the preform of the present invention, the average O₂ concentration of the core is preferably 10¹⁴ molecules/cm³ or less, more preferably 10¹³ molecules/cm³ or less. The average O₂ concentration of the cladding is preferably 10¹⁵ molecules/cm³ or less, more preferably 10¹⁴ molecules/cm³ or less, particularly preferably 10¹³ molecules/cm³ or less.

The method for measuring oxygen is as follows. A sample is excited by a laser at a wavelength of 1,064 nm or 765 nm, and a photoluminescence at a peak of 1,272 nm is measured. The measurement is performed using a detector capable of measuring a light having a wavelength of 1,272 nm (see, L. Skuja and B. Guttler, “Detection of Interstitial Oxygen Molecules in SiO₂ Glass by a Direct Photoexcitation of the Infrared Luminescence of Singlet O₂”, Physical Review Letters (U.S.A.), Vol. 77, No. 10, pp. 2093-2096 (1996)).

Since the concentration of oxygen is proportional to the peak intensity I of the photoluminescence spectrum, the average O₂ concentration can be calculated from the ratio with the photoluminescence peak intensity of a standard sample of which oxygen concentration is previously known. In the case where a standard sample is not available, since the peak intensity I_{R} of a Raman line having an intrinsic Raman shift of 490 cm⁻¹ becomes constant irrespective of the sample, the average O₂ concentration can be calculated from the ratio I/I_{R} between the peak intensity I of the photoluminescence spectrum and the Raman peak intensity I_{R} according to the relational expression:

Average O₂ concentration≈5×10¹⁷ I/I_{R} [cm⁻³].

If the average concentrations of the oxygen-deficient defects (ODC (I), (II)) in the core and cladding of the preform are high, the concentrations of the oxygen-deficient defects (ODC (I), (II)) in the core and cladding of the optical fiber produced using the preform become high. If an oxygen-deficient defect is present in the core and cladding of the optical fiber, an E′ center may be generated from the oxygen-deficient defect when irradiated with a high-energy light or an ultraviolet light. Generation of an E′ center causes a reduction in the transmittance of the optical fiber, an elevation of the absolute refractive index, a fluctuation of the refractive index distribution, or generation of fluorescence.

Also, an E′ center produced from the oxygen-deficient defect may be generated when drawing the preform to produce an optical fiber.

In the preform of the present invention, the average concentrations of the oxygen-deficient defects (ODC (I), (II)) in the core and the cladding are as very low as 10¹³ defects/cm³ or less and 10¹² defects/cm³ or less, respectively. Therefore, in the optical fiber produced using the preform, the number of oxygen-deficient defects and E′ centers present in the core and cladding become significantly small, as a result, an optical fiber scarcely causing deterioration upon irradiation with a high-energy light or an ultraviolet light and exhibiting excellent durability is obtained.

In the preform of the present invention, the average ODC (I) concentrations in the core and cladding are preferably 10¹² defects/cm³ or less.

In the preform of the present invention, the average ODC (II) concentrations in the core and cladding are preferably 10¹¹ defects/cm³ or less.

The method for measuring the average concentrations of ODC (I) and (II) is as follows.

First, a transmittance spectrum T % is measured using a spectrophotometer, and this is converted into an absorption coefficient α=−1/D×ln(T/100) cm⁻¹ (D is the sample thickness expressed by the “cm” unit).

Next, as for ODC (I), the peak intensity α cm⁻¹ in the absorption band having a peak at 163 nm is divided by 75×10¹⁸ cm²/defects, and the value obtained is taken as the average concentration of ODC (I).

As for ODC (II), the peak intensity α cm⁻¹ in the absorption band having a peak at 245 nm is divided by 45×10¹⁸ cm²/defects, and the value obtained is taken as the average concentration of ODC (II).

In the case where the average concentration of ODC (I) is 10¹³ defects/cm³ or less, the following measuring method is preferably used. With respect to a sample for measurement, specifically, a sample having a dimension of 15 mm×15 mm×100 mm with both surfaces of 15 mm×15 mm being mirror surfaces, a lamp light having a peak at 163 nm is made vertically incident on the mirror surface of 15 mm×15 mm. As for the lamp light, a deuterium lamp of 150 W or more is preferably used, because a light intensity to such an extent as enabling detection of a slight difference of transmittance can be obtained. This lamp light is made incident on a half mirror through a light chopper (80 kHz). One component of light split by the half mirror is made incident on a photomultiplier tube I, the other component is transmitted through the sample and then made incident on a photomultiplier tube II, and the output voltages of these light components are compared. Since the light intensity-voltage characteristics of the photomultiplier tubes I and II are usually not coincident, the average concentration of ODC (I) can be measured with high sensitivity by comparing the result with the ratio when a sample having a known ODC (I) concentration is measured under the same conditions.

In the case where the average concentration of ODC (II) is 10¹² defects/cm³ or less, the following measuring method is preferably used. With respect to a sample for measurement, specifically, a sample having a dimension of 15 mm×15 mm×30 mm and being entirely a mirror surface, a light such as ArF laser (wavelength: 193 nm) or KrF laser (wavelength: 248 nm) is made vertically incident on the mirror surface of 15 mm×15 mm, and the photoluminescence intensity of light near 280 nm coming from the sample is measured. The average concentration of ODC (II) can be measured with high sensitivity by comparing the value obtained with the photoluminescence intensity when a sample having a known ODC (II) concentration is measured under the same conditions, whereby.

In the preform of the present invention, the average F concentration of the cladding is as high as 7,000 ppm or more. Therefore, the number of structures that serve as precursors of defects such as E′ center or NBOHC is small, as a result, generation of a defect when drawing the preform to produce an optical fiber is suppressed.

Also, an Si—F structure is formed in the silica glass constituting the cladding. Therefore, the optical fiber produced using the preform exhibits enhanced resistance upon irradiation with a high-energy light or an ultraviolet light.

In the preform of the present invention, the average F concentration of the cladding is preferably 9,000 ppm or more, more preferably 10,000 ppm or more, particularly preferably 14,000 ppm or more.

In the preform of the present invention, the average chlorine concentrations in the core and cladding are preferably 50 ppm or less. When chlorine is contained, light resistance upon irradiation with an ultraviolet light deteriorates. The average chlorine concentrations in the core and cladding are more preferably 10 ppm or less, further preferably 1,000 ppb or less, and particularly preferably 10 ppb or less. Most preferably, chlorine is substantially not contained. The average chlorine concentration can be measured by fluorescent X-ray or SIMS (Secondary Ion Mass Spectrometer). The measurement limit of chlorine in these methods is 5 ppm. As for the measuring method with higher precision, a charged particle activation analysis is known. In this method, the measurement limit of chlorine is about 10 ppb. In the case of producing a silica glass by using a chlorine-containing raw material, for example, by using silicon tetrachloride as a raw material, the preform is considered to contain chlorine below the measurement limit. Accordingly, for producing a core or cladding containing substantially no chlorine, a chlorine-free raw material such as alkoxysilane represented by RₙSi(OR′)₄₋ₙ (wherein R and R′ each is a hydrogen atom or an alkyl group having a carbon number of 1 to 4) is preferably used. In the Examples described below, raw materials containing chlorine are used. However, in the case where raw materials containing chlorine are used, the chlorine concentration can be reduced to 10 ppb or less by firing a soot under a reduced pressure.

For the same reasons stated for the cladding, the core of the preform of the present invention also preferably contains F. However, when the average F concentration of the core is made high, since the light refractive index of the core decreases, the average F concentration of the cladding needs to be accordingly increased. In this meaning, when the core contains F, the average F concentration of the core needs to be adjusted to satisfy the following formula (1):

x≦A−((y−A)²+B)^{1/2} Formula (1)

wherein y is the average F concentration (ppm) of the cladding, x is the average F concentration (ppm) of the core, A=2.8×10⁶, and B=3.5×10¹⁰.

Formula 1 is derived by the following method.

Assuming that the refractive indexes n_{core} and n_{cladding} of the core and cladding satisfy the following formula (2), these refractive indexes are represented by the following formulae (3) and (4), respectively:

n=aF+b Formula (2)

n_{core}=aF_{core}+b Formula (3)

n_{cladding}=aF_{cladding}+b Formula (4)

wherein a and b both are a function of the wavelength.

Substituting formulae (3) and (4) into the definitional equation of NA:

NA=n²_{core}−n²_{cladding} Formula (5)

F_{core} is obtained as:

F_{core}=−b/a−{(F_{cladding}+b/a)²+(NA/a)²}^{1/2} Formula (6)

and when −b/a and (NA/a)² of formula (6) are expressed as A and B, respectively, then the following is obtained:

F_{core}=A−{(F_{cladding}−A)²+B}^{1/2} Formula (7)

Here, from the publications (K. Tsukuma, with other four persons, “Refractive index, dispersion and absorption of fluorine-doped silica glass in the deep UV region”, Journal of Non-Crystalline Solids (U.S.A.), Vol. 127, No. 2, pp. 191-196 (1991), and W. Fleming and D. L. Wood, “Refractive index dispersion and related properties in fluorine doped silica”, Applied Optics (U.S.A.), Vol. 22, No. 19, pp. 3102-3104 (1983)), a and b are determined by applying formula (2) with respect to the wavelengths of 237.8 nm and 365.0 nm. As a result, the values shown in Table 1 are obtained.

TABLE 1

| Wavelength λ (nm) | a | b |
|---|---|---|
| 237.8 | −4.889 × 10⁻⁷ | 1.5150 |
| 365.0 | −4.219 × 10⁻⁷ | 1.4741 |

In the case where NA=0.1, the relationship of A and B of formula 7 when determined are as shown in Table 2.

TABLE 2

| Wavelength λ (nm) | A | B |
|---|---|---|
| 237.8 | 3.098 × 10⁶ | 4.183 × 10¹⁰ |
| 365.0 | 3.493 × 10⁶ | 5.617 × 10¹⁰ |

The value at 173 nm is determined by extrapolating the above values and found to be about 2.8×10⁶ for A and about 3.5×10¹⁰ for B, and these values are taken as A and B at 173 nm.

According to the formulae above, in the case of producing an optical fiber where NA=0.12 and the average F concentration of the cladding is 15,000 ppm, this may be attained by adjusting the average F concentration of the core to be 5,000 ppm or less. The average F concentration of the core is preferably 1,000 ppm or less.

Here, the average F concentration of the core is preferably 100 ppm or more, more preferably 200 ppm or more, further preferably 300 ppm or more, and particularly preferably 500 ppm or more.

Here, the refractive index difference between the core and the cladding in the preform can be determined by measuring the refractive index distribution in the preform by a preform analyzer (for example, P104, manufactured by York Technology Ltd.).

In the preform of the present invention, since the average concentrations of ODC (I) and (II) and E′ center in the core and cladding are low, when a laser light at a long wavelength is propagated as a high-energy light or an ultraviolet light, the probability of high-order harmonic lights of the laser being absorbed by these defects is low. Accordingly, even when the intensity of the laser light is increased, the generation of a new defect due to absorption or the refractive index change accompanied with a volume reduction less occurs. That is, in an optical fiber produced using the preform of the present invention in which the concentrations of these defects are low, a transmission loss is scarcely caused also with a laser light of a long wavelength.

Also, introduction of F into the silica glass brings a reduction in the fictive temperature of glass and stabilization of the glass structure. A 3-membered ring or 4-membered ring appearing in the silica glass structure with a high fictive temperature is an energetically weak structure and, when a high-energy light or ultraviolet light is irradiated, these rings are relatively easily broken and induce a structural defect. When F is introduced into the silica glass, F selectively reacts with a weak bond portion such as 3-membered ring or 4-membered ring. Accordingly, high resistance to a high-energy light or ultraviolet light can be expected to be obtained by introducing F into the silica glass. In other words, an optical fiber having a high F concentration is considered to exhibit high resistance to a high-energy light or ultraviolet light.

Although described in detail below, in the case of producing the preform of the present invention, precision polishing and precision cleaning described below are applied in place of flame polishing which is usually performed in the preform production process. Owing to this, the preform of the present invention can be made low in the average OH concentration, average ODC (I) concentration and average ODC (II) concentration in the vicinity of the interface between the core and the cladding as compared with conventional preforms.

More specifically, in the preform of the present invention, in the region of ±10 μm from the interface between the core and the cladding, the average OH concentration is preferably 50 ppm or less, more preferably 10 ppm or less; the average ODC (I) concentration is preferably 10¹⁶ defects/cm³ or less, more preferably 10¹⁵ defects/cm³ or less, further preferably 10¹⁴ defects/cm³ or less, particularly preferably 10¹³ defects/cm³ or less, and most preferably 10¹² defects/cm³ or less; and the average ODC (II) concentration is preferably 10¹⁵ defects/cm³ or less, more preferably 10¹⁴ defects/cm³ or less, further preferably 10¹³ defects/cm³ or less, and particularly preferably 10¹² defects/cm³ or less. Here, when the distance to the core side from the interface is expressed by a positive value, the distance to the cladding side from the interface is expressed by a negative value.

Furthermore, in the preform of the present invention, in the region of ±20 μm from the interface between the core and the cladding, the average OH concentration is preferably from 0 to 10 ppm; the average ODC (I) concentration is preferably 10¹⁵ defects/cm³ or less, more preferably 10¹⁴ defects/cm³ or less, further preferably 10¹³ defects/cm³ or less, and particularly preferably 10¹² defects/cm³ or less; and the average ODC (II) concentration is preferably 10¹⁴ defects/cm³ or less, more preferably 10¹³ defects/cm³ or less, and further preferably 10¹² defects/cm³ or less.

The average ODC (I) concentration and average ODC (II) concentration in the regions of ±20 μm and ±10 μm from the interface between the core and the cladding are measured by a method in which elemental analysis of the cross-section of the preform is preformed, for example, by using a TOF-SIMS analysis method and from the obtained concentration distributions of F and hydrogen in the cross-section, the average ODC (I) concentration and the average ODC (II) concentration in the regions of ±20 μm and ±10 μm are determined. In the case of performing flame polishing, the amount of hydrogen increases due to an increase in the OH group and the amount of F decreases. The decrease of F suggests that the Si—F bond is broken and F is volatilized from the surface, and the produced bond deficient portion is (considered to become a defect such as ODC (I) or ODC (II). The average concentrations of ODC (I) and ODC (II) can be determined, after measuring a transmission spectrum, from the absorption coefficients at 163 nm and 245 nm according to the following formulae:

Average concentration of ODC (I) [defects/cm³]=absorption coefficient [cm⁻¹]/75×10⁻¹⁸ [defects⁻¹cm²]

Average concentration of ODC (II) [defects/cm³]=absorption coefficient [cm⁻¹]/45×10¹⁸ [defects⁻¹cm²]

However, since these defects produced by flame polishing are present only in the vicinity of the surface, for determining the concentration of the defect in the vicinity of the surface, the absorption coefficient in the above formula is calculated based on the thickness of the F-deficient layer determined from a TOF-SIMS analysis.

As for the measuring method of the average OH concentration in the regions of ±20 μm and ±10 μm from the interface between the core and the cladding, the hydrogen concentration distribution in the cross-section of the preform is measured by a TOF-SIMS analysis method, and averages of the concentration in the regions of ±20 μm and ±10 μm are determined. By this analysis method, the average hydrogen concentration to a depth of around 10 μm from the surface layer can be measured with good spatial resolution and good sensitivity, but it is unobvious whether the concentration of hydrogen corresponds to the concentration of OH group. Therefore, conformity with the results of TOF-SIMS analysis needs to be confined by determining the spatial distribution of the OH concentration in the vicinity of the surface layer by means of a microscopic Fourier transform infrared spectrophotometer (FT-IR) and thereby determining the concentration distribution of OH group. After determining the absorption coefficient of the absorption peak assigned to an OH group at 3,670 cm⁻¹ by an FT-IR spectroscopy, the concentration of OH group can be obtained according to the following formula:

Concentration of OH group [ppm]=absorption coefficient [cm⁻¹]/1.05×100 [cm⁻¹ppm⁻¹]

However, in the FT-IR spectroscopy, since the spatial resolution is not so high as in the TOF-SIMS analysis, an exact distribution of OH group cannot be determined. Accordingly, the exact concentration distribution of OH group is determined by the TOF-SIMS analysis.

In the measurement of the average ODC (I) concentration, average ODC (II) concentration and average OH concentration of the core or cladding alone, an SIMS analysis method excellent in terms of spatial resolution and measurement accuracy is used.

The preform of the present invention can be produced by a known preform production process, except that in producing the preform by using a core material and a cladding material satisfying the above-described properties as the core and the cladding, precision polishing and precision cleaning described below are applied in place of flame polishing usually performed in the preform production process. These core material and cladding material are also provided by the present invention.

The preform of the present invention can be produced, for example, by the following procedure.

### [Production Procedure 1]

A preform having a core and a cladding is produced by using a soot method (such as a VAD method (vapor-phase axial deposition method), an OVD method (outside vapor deposition method) or an MCVD method (modified chemical vapor deposition method)). In the case of a VAD or OVD method, a core material (core rod) having a diameter of about 20 mm is produced by using the VAD or OVD method. Specifically, a porous silica glass body formed by flame hydrolysis of a glass-forming raw material is heated to effect transparent vitrification, which is followed by mold pressing and/or processing, to thereby produce a core material (core rod) having a diameter of about 20 mm. Thereafter, a cladding containing a predetermined concentration of F is formed on the core material (core rod) by using the VAD or OVD method. The OVD method includes a method using oxyhydrogen flame and a method using plasma. However, with the method using oxyhydrogen flame, a large amount of water attaches to the surface of the core material and, at the time when the attached water is diffused into an inner part of the core, a large amount of F volatilizes. Therefore, an oxygen-deficient defect (ODC (I), (II)) or a precursor structure thereof is generated at the interface between the core and the cladding. As a result, there may be a possibility that the average ODC (I) concentration and the average ODC (II) concentration of the core of the resulting preform produced fail to be 10¹³ defects/cm³ or less and 10¹² defects/cm³ or less, respectively. For this reason, in the case of the OVD method, it is preferred to employ a method using plasma.

A core containing F can be produced, for example, by holding a porous silica glass body in an inert gas atmosphere containing a F compound gas (such as SiF₄, SF₆, CHF₃, CF₄, C₂F₆, C₃F₈, F₂, etc.) at room temperature or a temperature of 1,100° C. or lower for a period of from several tens minutes to several hours to thereby introduce F in the porous silica glass body, and then heating it up to 1,300° C. or higher in an inert gas or under a reduced pressure to thereby effect transparent vitrification. Also in the other methods described below, for forming a core containing F, it is necessary to carry out similar procedures to those described above.

As regards the production process of the cladding, for example, a porous glass body is produced on a core material (core rod) in an F compound gas-containing atmosphere and heat-treated at 500 to 1,300° C. in an atmosphere mainly comprising an inert gas to effect transparent vitrification, whereby a cladding containing a predetermined concentration of F with an average F concentration of 7,000 ppm or more can be formed. Alternatively, a porous glass body previously produced on a core material (core rod) is heat-treated at 500 to 1,300° C. in an inert gas atmosphere containing an F compound gas to introduce F into the porous glass body, and then heated at 1,300° C. or higher in an atmosphere containing oxygen and inert gases to effect transparent vitrification, whereby a cladding containing a predetermined concentration of F with an average F concentration of 7,000 ppm or more can be produced. Incidentally, also in the other method described below, for forming a cladding containing a predetermined concentration of F with an average F concentration of 7,000 ppm or more, it is necessary to carry out similar procedures to those described above.

In the case of an MCVD method, a cladding material containing a predetermined concentration of F is produced and a core is formed on the inner side of the cladding material by using the MCVD method.

### [Production Procedure 2]

A core material (core rod) having a diameter of about 20 mm is produced by using a soot method (such as a VAD method (vapor-phase axial deposition method), an OVD method (outside vapor deposition method), or an MCVD method (inside chemical vapor deposition method)). More specifically, a porous silica glass body formed by flame hydrolyzing a glass-forming raw material is heated to effect transparent vitrification, followed by molding and processing, to thereby produce a core material (core rod) having a diameter of about 20 mm.

A cladding material (cladding tube) containing a predetermined concentration of F is produced using a soot method (such as a VAD method, an OVD method or an MCVD method).

The core material (core rod) is inserted into the cladding material (cladding tube) by using a rod-in-tube method to fabricate a preform.

In producing a preform by the production procedure 1 or 2, the flatness of the portion that serves as the interface between the core and the cladding of the preform needs to be enhanced by removing foreign matters before forming a core-cladding structure. For this purpose, flame polishing is usually applied.

In the case of producing a preform by using a VAD or OVD method in the production procedure 1, after forming a core material (core rod) but before forming a cladding on the core material (core rod) by using the VAD or OVD method, flame polishing is usually applied for the purpose of removing foreign matters on the outer surface of the core material (core rod) and enhancing the flatness. In the case of producing a preform by using an MCVD method in the production procedure 1, after forming a cladding material but before forming a core on the inner side of the cladding material by using the MCVD method, flame polishing is usually applied for the purpose of removing foreign matters on the inner surface of the cladding and enhancing the flatness. In the case of producing a preform by the production procedure 2, before fabricating a preform by using a rod-in-tube method, flame polishing is usually performed for the purpose of removing foreign matters on the outer surface of the core material (core rod) as well as on the inner surface of the cladding material (cladding tube) and enhancing the flatness.

In producing the preform of the present invention, this flame polishing becomes a problem.

In the case of using an MCVD method in the production procedure 1, usually applied flame polishing is to be applied to a cladding material having a high average F concentration of 7,000 ppm or more. During flame polishing, F volatilizes from the cladding material to generate oxygen-deficient defects (ODC (I), (II)) or precursor structures thereof. As a result, in the preform produced, the cladding fails to have an average ODC (I) concentration of 10¹³ defects/cm³ or less and an average ODC (II) concentration of 10¹² defects/cm³ or less.

Incidentally, it has been conventionally unknown that when flame polishing is applied to a cladding material having a high average F concentration of 7,000 ppm or more, F volatilizes from the cladding material to generate oxygen-deficient defects (ODC (I), (II)) or precursor structures thereof, and this is new knowledge found by the present inventors.

The portion from which F volatilizes during flame polishing is mainly the vicinity of the surface of the cladding material, that is, the vicinity of the inner surface and the vicinity of the outer surface of the cladding material. Of these surfaces, the inner surface of the cladding material forms the interface between the core and the cladding when fabricating the preform. Therefore, volatilization of F from the vicinity of the inner surface of the cladding material and generation of oxygen-deficient defects (ODC (I), (II)) or precursor structures thereof become problems in particular. Here, the term “vicinity of the inner surface of the cladding material” indicates the portion to a depth of about 20 μm from the inner surface of the cladding material.

The same applies to the production procedure 2. Usually applied flame polishing is to be applied to a cladding material (cladding tube) having a high average F concentration of 7,000 ppm or more. F volatilizes from the vicinity of the inner surface and the vicinity of the outer surface of the cladding material (cladding tube) during flame polishing, and oxygen-deficient defects; (ODC (I), (II)) or precursor structures thereof are generated. As a result, in the preform produced, the cladding fails to have an average ODC (I) concentration of 10¹³ defects/cm³ or less and an average ODC (II) concentration of 10¹² defects/cm³ or less.

In the case of using an VAD or OVD method in the production procedure 1, since the core material (core rod) to be subjected to flame polishing is free from F or has a low F concentration, the above-described problem due to volatilization of F does not occur, but flame polishing of the core material (core rod) brings about a problem in the vicinity of the outer surface of the core material (core rod), for example, the OH concentration becomes high or a defect precursor structure is generated. Here, the term “vicinity of the outer surface of the core material (core rod)” indicates the portion to a depth of about 20 μm from the outer surface of the core material (core rod).

The same problem as this also arises when a core material (core rod) is flame polished in the production procedure 2.

Furthermore, also in fabricating a preform by using a rod-in-tube method, heat is more or less applied to the core material and the cladding material, which brings a possibility of causing volatilization of F and generation of oxygen-deficient defects (ODC (I), (II)) or precursor structures thereof. For preventing this, the heating atmosphere in the rod-in-tube process is preferably made to be an atmosphere with little water content, more preferably an atmosphere containing an F compound gas, such as SiF₄.

In producing the preform of the present invention, for the purpose of removing foreign matters on the portion that serves as the interface between the core and the cladding of the preform and thereby enhancing the flatness, precision polishing and precision cleaning described below need to be applied, in place of applying flame polishing. In the production procedures 1 and 2, it is preferred to grind the outer circumference of the preform so as to obtain a desired core/cladding ratio. Particularly, in the production procedure 2, it is necessary to grind the outer circumference because, in the rod-in-tube process, the cladding tube is processed with oxyhydrogen flame from the outside.

In the case of producing a preform by using a VAD or OVD method in the production procedure 1, after forming a core material (core rod) but before forming a cladding on the core material (core rod) by using the VAD or OVD method, precision polishing and precision cleaning described below need to be applied to the outer surface of the core material (core rod) for the purpose of removing foreign matters and enhancing the flatness. In the case of producing a preform by using an MCVD method in the production procedure 1, after forming a cladding material but before forming a core on the inner side of the cladding material by using the MCVD method, precision polishing and precision cleaning described below need to be applied to the inner surface of the cladding material for the purpose of removing foreign matters and enhancing the flatness. In the case of producing a preform by the production procedure 2, before fabricating a preform by using a rod-in-tube method, precision polishing and precision cleaning described below need to be applied to the cuter surface of the core material (core rod) as well as to the inner surface of the cladding material (cladding tube) for the purpose of removing foreign matters and enhancing the flatness.

Here, precision polishing and precision cleaning indicate a surface polishing method and a surface cleaning method, other than flame polishing, which are applied to create a required surface profile on the portion that serves as the interface between the core and the cladding of the preform. Specifically, the precision polishing and precision cleaning are preferably a surface polishing method and a surface cleaning method, which can satisfy the following conditions (1) to (3):

(1) the surface after the treatments has; a surface roughness Ra of 10 nm or less,

(2) the surface after the treatments is free from a particle with a size of 50 μm or more, and

(3) the surface after the treatments is free from a scratch with a width of 11 μm or more.

If a preform is produced using a core and a cladding, either one or both of which fail to satisfy the conditions (1) to (3), there may be a possibility that a bubble, a foreign matter or the like is produced at the interface between the core and the cladding to cause a trouble of, for example, deteriorating the strength of the fiber or deteriorating the property of the fiber.

The surface roughness Ra of the surface after the treatments is preferably 5 nm or less, more preferably 1 nm or less. It is more preferred that a particle with a size of 10 μm or more is not present on the surface after the treatments.

The surface roughness Ra of the surface after the treatments can be determined by using, for example, an ultrahigh precision three-dimensional profilometer UAP3 (manufactured by Panasonic Corp.) and measuring the surface roughness Ra of 10 mm in each of the axial direction and the circumferential direction along the outer circumferential surface of the core and the inner circumferential surface of the cladding.

The particle and scratch on the surface after treatment can be observed by using a high-brightness light source (50,000 lux) and confirming light scattering due to particles and scratch defects.

Examples of the precision polishing include precision polishing (mechanical polishing) which is applied to an optical surface of an optical member, such as lens surface.

As for the precision cleaning, examples of a wet cleaning method include solvent cleaning using an alkaline solvent, cleaning with functional water such as ozone water, electrolytic ionized water or hydrogen water, ultrasonic cleaning, microbubble cleaning, and HF cleaning; and examples of a dry cleaning method include etching gas cleaning using an etching gas such as CF₄ and C₄F₈, excimer lamp cleaning, plasma cleaning and ion cleaning.

What polishing method is applied as the precision polishing or what cleaning method is applied as the precision cleaning may be appropriately selected according to a part to which the precision polishing or precision cleaning is applied.

In the case of producing a preform by using a VAD or OVD method in the production procedure 1, the outer surface of the core material (core rod) is subjected to precision polishing (mechanical polishing) and then to wet cleaning or dry cleaning as the precision cleaning. In the case of producing a preform by using a MCVD method in the production procedure 1, the inner surface of the cladding material (cladding tube) is subjected to precision polishing (mechanical polishing) and then to wet cleaning or dry cleaning as the precision cleaning. In the case of producing a preform by the production procedure 2, the outer surface of the core material (core rod) and the inner surface of the cladding material (cladding tube) is subjected to precision polishing (mechanical polishing) and then to wet cleaning or dry cleaning as the precision cleaning.

By applying the above-described precision polishing and precision cleaning in place of flame polishing that is applied for the purpose of removing foreign matters and enhancing the flatness on the portion that serves as the interface between the core and the cladding of the preform, volatilization of F in the vicinity of the inner surface of the cladding material and the resultant generation of oxygen-deficient defects (ODC (I), (II)) or precursor structures thereof can be prevented. Also, a problem such as increase in the OH concentration in the vicinity of the outer surface of the core material or generation of a defect precursor structure can be prevented from occurring.

Since mechanical equipment for precision polishing the outer circumference of a core material (core rod) or the inner surface of a cladding material (cladding tube) is not present, and since finishing with good precision in terms of circularity, linearity or the like takes much time, it is common to obtain a core material (core rod) or cladding material (cladding tube) with good precision generally by drawing or flame polishing. The same applies to precision cleaning. In particular, foreign matters attached to the inner surface of a cladding material are difficult to remove by cleaning. Therefore, the foreign matters are generally removed by flame polishing.

However, when the F-containing glass is heated in an atmosphere containing water, F volatizes from the glass surface. In the case of performing flame polishing, since the polishing is usually performed with oxyhydrogen flame, heating is performed in an atmosphere containing a large amount of water to decrease the F concentration on the glass surface as compared with that in the inside. As a result, the F concentration of the core material is decreased in the vicinity of the portion that serves as the interface between the core and the cladding, and when a preform is fabricated, the refractive index in the vicinity of the interface between the core and the cladding becomes high as compared with the inside of the core, which causes wavefront distortion of the output light. In addition, this may possibly bring about a problem that the propagation loss increases.

Accordingly, for precision-polishing the outer circumference of a core material (core rod) or the inner surface of a cladding material (cladding tube), a core material (core rod) or cladding material (cladding tube) with good precision is preferably obtained through precision polishing by producing a jig suited for the outer diameter or inner diameter and performing an operation of gradually adjusting the profile by the combination of an abrasive grain for polishing and the jig, and also enhancing the surface smoothness.

Here, in order to produce no scratches, it is preferred to gradually reduce the size of the abrasive grain for polishing. More specifically, the size of the abrasive grain for polishing is changed in order of #240, #400, #600, #800 and #1000 and thereafter, mirror polishing with cerium oxide is performed, whereby a mirror surface free from scratches can be obtained. Even if the size of the abrasive grain for polishing is instead non-gradually reduced, for example, to #240, #600 and #1000, a mirror surface may be obtained by the subsequent mirror polishing, but there may be the case where a latent scratch is present.

The precision cleaning is also preferably performed by providing special cleaning equipment and performing ultrasonic cleaning to remove foreign matters. In particular, since a chemical solution is difficult to circulate in the cladding material (cladding tube), the number of particles on the inner wall of a cladding material (cladding tube) can be hardly reduced by a normal cleaning method. For this reason, dipping in an aqueous acidic solution is preferably used in combination for the cleaning of a cladding material (cladding tube). After the cleaning, the material is dipped in isopropyl alcohol (IPA) and then dried. If the material is subjected to a high-temperature thermal step such as rod-in-tube while water or alcohol is still attaching to the glass surface, F reacts with the hydroxyl group and volatilizes in the form of HF to form a defect. Therefore, water and the like on the surface are preferably reduced as much as possible. In this meaning, the drying is finally performed at 100° C. or higher.

In the production procedures 1 and 2, it is preferred to grind the outer circumference of the preform after the core material and the cladding material are integrated, so as to provide a preform having a desired core/cladding ratio. Particularly, in the production procedure 2, it is preferred to grind the outer circumference by at least 1 mm because, in the rod-in-tube step, the cladding tube is processed with oxyhydrogen flame from the outside. After the grinding, it is preferred to carry out polishing to provide a preform. In this instance, it is preferred to make the surface of the preform to be the C-grade or higher according to the Mil-O-13830 A standard. The surface of the preform is preferably free from a scratch having a width of 25 μm or greater, more preferably free from a scratch having a width of 21 μm or greater, further preferably free from a scratch having a width of 16 μm or greater, particularly preferably free from a scratch having a width of 11 μm or greater. For the grinding of the circumference of the preform, known grinding methods may be used. For example, the grinding can be carried out by attaching a preform to a working lathe, grinding it with a diamond wheel, while gradually reducing the abrasive grain size of the wheel. To eliminate a scratch having a large line width, it is preferred to carry out polishing by a known method. For example, the polishing can be carried out by attaching a preform to a working lathe, conducting polishing while supplying a cerium oxide slurry. It is more preferred to carry out precision polishing, similarly to the case of the outer circumference of the core material (core rod).

The preform of the present invention produced by the above-described procedure is drawn with adjusting the speed of the drawing machine to give a predetermined outer diameter while melting the preform under heating in a drawing furnace, whereby an energy-transmitting or ultraviolet ray-transmitting optical fiber can be produced.

### EXAMPLES

### Examples 1 to 3

Core materials and cladding materials were produced by a VAD method. The F concentration and OH concentration in each sample were adjusted by the F compound gas concentration, temperature, etc. at the time of treating a porous silica glass body with an F compound gas.

The produced core materials and cladding materials were processed by a peripheral grinding machine and a cylinder grinding machine and then polished with an abrasive grain for polishing GC #240, GC #400, FO #600, FO #800 and FO #1000 (trade names, produced by Fujimi Corp.) each formed into a slurry. Thereafter, precision polishing was performed using MIREK (trade name, produced by Mitsui Mining & Smelting Co., Ltd.). In the core materials and cladding materials after precision polishing, the non-circularity was 2 or less, the particle was 0.1 μm or less in diameter, and the scratch was 11 μm in width. Subsequently, precision cleaning was applied in place of a usual flame polishing step using oxyhydrogen flame. The precision cleaning here is composed by: subjecting the core material and cladding material each to dipping in an aqueous nitric solution for 12 hours as a pretreatment; then ultrasonic cleaning with pure water; and subjecting each material to ultrasonic cleaning in an IPA cleaning bath as a post-treatment; and then drying at 100° C. On the surface after precision cleaning, the surface roughness Ra is 10 nm or less, a particle with a size of 50 μm or more is not present, and a scratch with a width of 11 μm or more is not present.

### Example 4

A core material and a cladding material were produced by a VAD method in the same manner as in Examples 1 to 3. The produced core material and cladding material each was subjected to usual polishing using alumina and cerium oxide and then to a flame polishing process using oxyhydrogen flame. The flame polishing of the cladding material was performed by a method of treating the outside with oxyhydrogen while allowing an oxygen gas to flow in the inside. Here, the temperature raise of the core material and the cladding material in the flame polishing step was measured with a radiation thermometer (Marathon MM-Model G5H, produced by Raytek Corporation). The measurement value was 2,000° C.

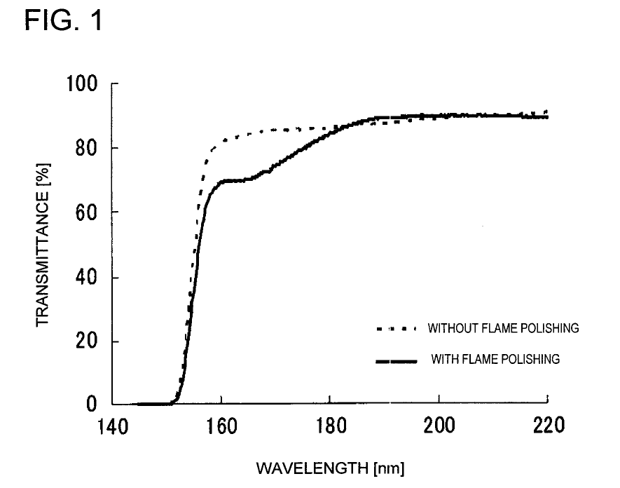

The dotted line in FIG. 1 shows the transmittance spectrum measured by making rays incident in the direction perpendicular to the side face of the core material of the sample not subjected to flame polishing (Example 1). The solid line in FIG. 1 shows the transmittance spectrum measured with the core material of the sample subjected to flame polishing (Example 4). The transmission spectra of the core material samples of Examples 1 to 3 are almost the same and therefore, the transmission spectra of Examples 2 and 3 are omitted. The thickness is 3 mm in all samples. As shown in FIG. 1, in the core material sample of Example 4, an absorption peak corresponding to ODC (I) was observed in the vicinity of 165 nm, whereas in the core material samples of Examples 1 to 3, the absorption peak was not observed. A peak corresponding to ODC (II) was not observed in any sample. Taking into consideration the thickness (3 mm) of each sample, the absorption coefficient at 165 nm of the core material samples of Examples 1 and 4 were 0.9 cm⁻¹ and 0.32 cm⁻¹, respectively. Since absorption derived from a defect was not observed in the core material sample of Example 1, the average concentration of ODC (I) in a thickness of 3 mm in the core material sample of Example 4 was determined as 7.7×10¹⁵ defects/cm³ by dividing the difference in the absorption coefficient therebetween, that is, 0.58 cm⁻¹, by 7.5×10¹⁷ cm⁻³/defects/cm. On the other hand, since an absorption peak could not be confirmed in the core material sample of Example 1, the average concentration in a thickness of 3 mm is presumed to be 10¹⁵ defects/cm³ or less.

Furthermore, with respect to the core materials and cladding materials of Examples 1 to 3, a sample having a dimension of 15 mm×15 mm×100 mm with both surfaces of 15 mm×15 mm being a mirror surface is produced, only the light component at 165 nm of a lamp light is taken out, and the lamp light is vertically irradiated on the mirror surface of 15 mm×15 mm of the sample. The average concentration of ODC (I) is determined through the procedure described in paragraph [0030] by using a light chopper and found to be 1×10¹² defects/cm³ or less.

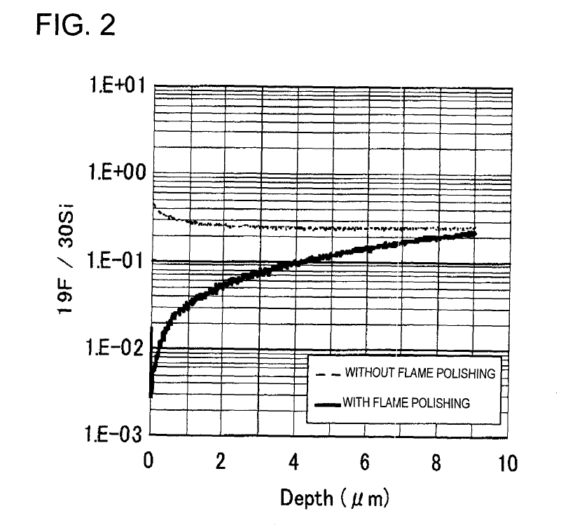

The core material samples of Examples 1 to 3 and Example 4 were subjected to SIMS analysis. FIG. 2 shows the results of SIMS analysis. In this case, the results were also almost the same among Examples 1 to 3 and therefore, the results of only Example 1 are shown. Since the Si amount can be regarded as constant in all samples, the signal intensity of F was normalized by the constant signal intensity. As a result, in the core material sample of Example 1 not subjected to flame polishing, the F concentration was constant as shown by the dotted line, whereas in the core material sample of Example 4 subjected to flame polishing, as shown by the solid line, the F concentration was almost 0 ppm in the very vicinity of the surface, and it was found that F at a depth of up to about 10 μm from the surface was effected by volatilization.

ODC (I) of the core material sample of Example 4, determined from FIG. 1, is presumed to be produced in this surface layer of 10 μm. Accordingly, in terms of the value in this 10 μm region, the concentration of ODC (I) in the core material sample of Example 4, determined above, becomes:

7.7×10¹⁵ defects/cm³×3 mm/10 μm=2.3×10¹⁸ defects/cm³.

In this way, the average concentration of ODC (I) in the core material sample of Example 4 is 2.3×10¹⁸ defects/cm³ in the portion to a depth of 10 μm from the surface.

On the other hand, the average concentration of ODC (I) in the core material samples of Examples 1 to 3 can be considered to be almost constant at 10¹³ defects/cm³ or less even in the surface layer of 10 μm, because the F concentration is constant as described above.

The ODC (I) concentration is estimated in the same manner also on the cladding materials of Examples 1 to 4 by transmitting light in the side surface direction and measuring the transmittance. The thus-obtained measurement results (average values) of the OH concentration, O₂ concentration, ODC (I) concentration, ODC (II) concentration and F concentration of the core materials and cladding materials of Examples 1 to 4 are shown in Table 3. For the average concentration of ODC (I) within 20 μm from the surface layer, the following was used as the product obtained by averaging the value for 10 μm by 20 μm.

2.3×10¹⁸ defects/cm³×10 μm/20 μm=1.2×10¹⁸ defects/cm³.

TABLE 3

| | | OH | O₂ | ODC (I) | ODC (II) | F |
|---|---|---|---|---|---|---|
| | | Concentration | Concentration | Concentration | Concentration | Concentration |
| | | (ppm) | (molecules/cm³) | (defects/cm³) | (defects/cm³) | (ppm) |
| Example 1 | Core material | 1 | ≦1 × 10¹⁵ | ≦1 × 10¹² | ≦1 × 10¹² | 300 |
| | Cladding material | ≦1 | ≦1 × 10¹⁶ | ≦1 × 10¹² | ≦1 × 10¹² | 8000 |
| Example 2 | Core material | 5 | ≦1 × 10¹⁵ | ≦1 × 10¹² | ≦1 × 10¹² | 200 |
| | Cladding material | ≦1 | ≦1 × 10¹⁶ | ≦1 × 10¹² | ≦1 × 10¹² | 8500 |
| Example 3 | Core material | 8 | ≦1 × 10¹⁵ | ≦1 × 10¹² | ≦1 × 10¹² | 150 |
| | Cladding material | ≦1 | ≦1 × 10¹⁶ | ≦1 × 10¹² | ≦1 × 10¹² | 14000 |
| Example 4 | Core material | 5 | ≦1 × 10¹⁵ | 7.7 × 10¹⁵ | ≦1 × 10¹² | 200 |
| | Cladding material | ≦1 | ≦1 × 10¹⁶ | 5 × 10¹³ | ≦1 × 10¹² | 8500 |

Preforms were produced using the core materials and cladding materials of Examples 1 to 4 by a rod-in-tube method.

The measurement results (average) of the OH concentration, O₂ concentration, ODC (I) concentration, ODC (II) concentration and F concentration in the regions of ±10 μm and ±20 μm from the interface between the core and the cladding of each preform are shown in Table 4.

TABLE 4

| | Measured Region | OH | O₂ | ODC (I) | ODC (II) |
|---|---|---|---|---|---|
| | (distance from core- | Concentration | Concentration | Concentration | Concentration |
| | cladding interface) | (ppm) | (molecules/cm³) | (defects/cm³) | (defects/cm³) |
| Example 1 | Region of ±10 μm | 1 | 3 × 10¹⁵ | ≦1 × 10¹² | ≦1 × 10¹² |
| | Region of ±20 μm | 1 | 2 × 10¹⁵ | ≦1 × 10¹² | ≦1 × 10¹² |
| Example 2 | Region of ±10 μm | 1 | 3 × 10¹⁵ | ≦1 × 10¹² | ≦1 × 10¹² |
| | Region of ±20 μm | 1 | 2 × 10¹⁵ | ≦1 × 10¹² | ≦1 × 10¹² |
| Example 3 | Region of ±10 μm | 1 | 3 × 10¹⁵ | ≦1 × 10¹² | ≦1 × 10¹² |
| | Region of ±20 μm | 1 | 2 × 10¹⁵ | ≦1 × 10¹² | ≦1 × 10¹² |
| Example 4 | Region of ±10 μm | 400 | 8 × 10¹⁶ | 2.3 × 10¹⁸ | 2 × 10¹⁴ |
| | Region of ±20 μm | 300 | 6 × 10¹⁶ | 1.2 × 10¹⁸ | 1 × 10¹³ |

### Examples 5 to 8

A cladding was formed on the core materials of Examples 1 to 4 by using a VAD method to produce fiber preforms.

The measurement results (average) of the OH concentration, O₂ concentration, ODC (I) concentration, ODC (II) concentration and F concentration in the core and cladding of each preform are shown in Table 5.

TABLE 5

| | | OH | O₂ | ODC (I) | ODC (II) | F |
|---|---|---|---|---|---|---|
| | | Concentration | Concentration | Concentration | Concentration | Concentration |
| | | (ppm) | (molecules/cm³) | (defects/cm³) | (defects/cm³) | (ppm) |
| Example 5 | Core | 1 | ≦1 × 10¹⁶ | ≦1 × 10¹² | ≦1 × 10¹² | 300 |
| | Cladding | ≦1 | ≦1 × 10¹⁶ | ≦1 × 10¹² | ≦1 × 10¹² | 7500 |
| Example 6 | Core | 5 | ≦1 × 10¹⁶ | ≦1 × 10¹² | ≦1 × 10¹² | 200 |
| | Cladding | ≦1 | ≦1 × 10¹⁶ | ≦1 × 10¹² | ≦1 × 10¹² | 8300 |
| Example 7 | Core | 8 | ≦1 × 10¹⁶ | ≦1 × 10¹² | ≦1 × 10¹² | 150 |
| | Cladding | ≦1 | ≦1 × 10¹⁶ | ≦1 × 10¹² | ≦1 × 10¹² | 13500 |
| Example 8 | Core | 5 | 1 × 10¹⁷ | 8 × 10¹⁵ | 8 × 10¹⁵ | 200 |
| | Cladding | ≦1 | ≦1 × 10¹⁶ | ≦1 × 10¹² | ≦1 × 10¹² | 8500 |

The measurement results (average) of the OH concentration, O₂ concentration, ODC (I) concentration, ODC (II) concentration and F concentration in the regions of ±10 μm and ±20 μm from the interface between the core and the cladding of each preform are shown in Table 6.

TABLE 6

| | Measured Region | OH | O₂ | ODC (I) | ODC (II) |
|---|---|---|---|---|---|
| | (distance from core- | Concentration | Concentration | Concentration | Concentration |
| | cladding interface) | (ppm) | (molecules/cm³) | (defects/cm³) | (defects/cm³) |
| Example 5 | Region of ±10 μm | 1 | ≦1 × 10¹⁵ | ≦1 × 10¹² | ≦1 × 10¹² |
| | Region of ±20 μm | 1 | ≦1 × 10¹⁵ | ≦1 × 10¹² | ≦1 × 10¹² |
| Example 6 | Region of ±10 μm | 1 | ≦1 × 10¹⁵ | ≦1 × 10¹² | ≦1 × 10¹² |
| | Region of ±20 μm | 1 | ≦1 × 10¹⁵ | ≦1 × 10¹² | ≦1 × 10¹² |
| Example 7 | Region of ±10 μm | 1 | ≦1 × 10¹⁵ | ≦1 × 10¹² | ≦1 × 10¹² |
| | Region of ±20 μm | 1 | ≦1 × 10¹⁵ | ≦1 × 10¹² | ≦1 × 10¹² |
| Example 8 | Region of ±10 μm | 400 | 8 × 10¹⁸ | 8 × 10¹⁸ | 2 × 10¹⁷ |
| | Region of ±20 μm | 300 | 3 × 10¹⁸ | 2 × 10¹⁸ | 5 × 10¹⁶ |

Examples 1 to 3 and Examples 5 to 7 are Examples of the present invention, and Examples 4 and 8 are Comparative Examples. In Examples 1 to 3 where the average concentration of ODC (I) is 10¹⁵ defects/cm³ or less even in the region of 10 μm from the surface, the transmittance at a wavelength of 165 nm is as good as 80% or more. In Examples 4 and 9 where the average concentration of ODC (I) is 1018 defects/cm³ or more, the transmittance at a wavelength of 165 nm is 70% or less.

While the present invention has been described in detail and with reference to specific embodiments thereof, it will be apparent to one skilled in the art that various changes and modifications can be made therein without departing from the spirit and scope thereof.

The present application is based on Japanese Patent Application No. 2008-018715 filed on Jan. 30, 2008, and the contents thereof are herein incorporated by reference.

1. A core material for use in an energy-transmitting or ultraviolet light-transmitting optical fiber preform, comprising a silica glass, and
having an average OH concentration of from 0 to 10 ppm, an average O₂ concentration of ≦10¹⁵ molecules/cm³, an average ODC (I) concentration of ≦10¹³ defects/cm³, an average ODC (II) concentration of ≦10¹² defects/cm³, and an average F concentration of ≦1,000 ppm.

2. The core material for use in an energy-transmitting or ultraviolet light-transmitting optical fiber preform as claimed in claim 1, wherein the average ODC (I) concentration is ≦10¹² defects/cm³.

3. A cladding material for use in an energy-transmitting or ultraviolet light-transmitting optical fiber preform, comprising a silica glass, and
having an average OH concentration of from 0 to 10 ppm, an average F concentration of ≧7,000 ppm, an average O₂ concentration of ≦10¹⁶ molecules/cm³, an average ODC (I) concentration of ≦10¹³ defects/cm³, and an average ODC (II) concentration of ≦10¹² defects/cm³.

4. The cladding material for use in an energy-transmitting or ultraviolet light-transmitting optical fiber preform as claimed in claim 3, wherein the average ODC (I) concentration is ≦10¹² defects/cm³.

5. An energy-transmitting or ultraviolet light-transmitting optical fiber preform having a core and a cladding, each comprising a silica glass,
wherein the core has an average OH concentration of 0 to 10 ppm, an average O₂ concentration of ≦10¹⁵ molecules/cm³, an average ODC (I) concentration of ≦10¹³ defects/cm³, an average ODC (II) concentration of ≦10¹² defects/cm³, and an average F concentration of ≦1,000 ppm, and
wherein the cladding has an average OH concentration of 0 to 10 ppm, an average F concentration of ≧7,000 ppm, an average O₂ concentration of ≦10¹⁶ molecules/cm³, an average ODC (I) concentration of ≦10¹³ defects/cm³, and an average ODC (II) concentration of ≦10¹² defects/cm³.

6. The energy-transmitting or ultraviolet light-transmitting optical fiber preform as claimed in claim 5, wherein the core has an average ODC (I) concentration of ≦10¹² defects/cm³ and the cladding has an average ODC (I) concentration of ≦10¹² defects/cm³.

7. The energy-transmitting or ultraviolet light-transmitting optical fiber preform as claimed in claim 5 or 6, wherein the core contains F in a concentration satisfying the following formula:
x≦2.8×10⁶−{(y−2.8×10⁶)²+3.5×10¹⁰}^{1/2}
wherein y is the average F concentration (ppm) of the cladding and x is the average F concentration (ppm) of the core.

8. The energy-transmitting or ultraviolet light-transmitting optical fiber preform as claimed in any one of claims 5 to 7, wherein the region of ±20 μm from the interface between the core and the cladding has an average OH concentration of from 0 to 10 ppm, an average ODC (I) concentration of ≦10¹⁵ defects/cm³ and an average ODC (II) concentration of ≦10¹⁴ defects/cm³.

9. The energy-transmitting or ultraviolet light-transmitting optical fiber preform as claimed in any one of claims 5 to 8, wherein the region of ±10 μm from the interface between the core and the cladding has an average OH concentration of ≦50 ppm, an average ODC (I) concentration of ≦10¹⁶ defects/cm³ and an average ODC (II) concentration of ≦10¹⁵ defects/cm³.

10. A process for producing an energy-transmitting or ultraviolet light-transmitting optical fiber preform having a core and a cladding, each comprising a silica glass, the process comprising subjecting
a core material having an average OH concentration of 0 to 10 ppm, an average O₂ concentration of ≦10¹⁵ molecules/cm³, an average ODC (I) concentration of ≦10¹³ defects/cm³, an average ODC (II) concentration of ≦10¹² defects/cm³, and an average F concentration of ≦1,000 ppm, and
a cladding material having an average OH concentration of 0 to 10 ppm, an average F concentration of ≧7,000 ppm, an average O₂ concentration of ≦10¹⁶ molecules/cm³, an average ODC (I) concentration of ≦10¹³ defects/cm³, and an average ODC (II) concentration of ≦10¹² defects/cm³
to precision polishing and precision cleaning and then to fabrication of an optical fiber preform.

11. The process for producing an energy-transmitting or ultraviolet light-transmitting optical fiber preform as claimed in claim 10, wherein the average ODC (I) concentration of the core material is ≦10¹² defects/cm³ and the average ODC (I) concentration of the cladding material is ≦10¹² defects/cm³.

12. The process for producing an energy-transmitting or ultraviolet light-transmitting optical fiber preform as claimed in claim 10 or 11, wherein the core material contains F in a concentration satisfying the following formula:
x≦2.8×10⁶−{(y−2.8×10⁶)²+3.5×10¹⁰}^{1/2}
wherein y is the average F concentration (ppm) of the cladding material and x is the average F concentration (ppm) of the core material.

13. The process for producing an energy-transmitting or ultraviolet light-transmitting optical fiber preform as claimed in any one of claims 10 to 12, wherein the precision polishing and precision cleaning satisfy the following conditions (1) to (3):
(1) the surface after the treatments has a surface roughness Ra of 10 nm or less,
(2) the surface after treatments is free from a particle with a size of 50 μm or more, and
(3) the surface after treatments is free from a scratch with a width of 11 μm or more.
